(19) United States
(12) Patent Application Publication
(10) Pub. No.: US 2005/0240584 A1
(43) Pub. Date: Oct. 27, 2005

(54) Data protection using data distributed into snapshots

(75) Inventors: Brian Patterson, Boise, ID (US); Lee Nelson, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 10/829,715

(22) Filed: Apr. 21, 2004

(51) Int. Cl. G06F 17/30

(52) U.S. Cl. 707/8

(57) ABSTRACT

A method of protecting data includes distributing data across a plurality of snapshots of a parent logical unit (LUN) when data of the parent LUN diverges from the snapshots.

### BACKGROUND OF THE INVENTION

Data storage administrators have long used system backups to ensure protection of valuable data. Backups have conventionally been performed during shutdown of other applications, a process that often performed at night or off-hours. The highly desirable utility of continuously available storage systems is not available for such traditional backup operations.

Snapshot techniques have been developed to facilitate backup operations that avoid disruption of other operations. A snapshot image may be used as a source of the backup. A snapshot is commonly taken by quiescing applications and performing a copy that is created nearly instantly so that a use notices essentially no delay.

A common reason to restore information is user error, such as inadvertent deletion or modifications to a file that the user subsequently would like to reverse. Snapshot techniques enable the capability to retain a stored copy of the data in ready availability for fast and efficient data location and restoration.

### SUMMARY

In accordance with an embodiment of a data storage system, a method of protecting data includes distributing data across a plurality of snapshots of a parent logical unit (LUN) when data of the parent LUN diverges from the snapshots.

### BRIEF DESCRIPTION OF THE DRAWINGS

Embodiments of the invention relating to both structure and method of operation, may best be understood by referring to the following description and accompanying drawings.

FIGS. 1A and 1B are schematic block diagrams that illustrate data structures used in a storage system for implementing snapshot functionality in which granularity of an array's maps is the same as the granularity that the divergence between the snapshot copy and the original data is recorded within the array.

FIGS. 2A and 2B are schematic block diagrams that illustrate data structures used in a storage system for implementing snapshot functionality in which granularity of an array's maps is not the same as the granularity that the divergence between the snapshot copy and the original data is recorded within the array.

FIGS. 3A and 3B are schematic block diagrams depicting data structures used in an embodiment of a storage system that implements snapshot functionality in which data is distributed across a plurality of snapshots.

FIGS. 4A, 4B, and 4C are pictorial block diagrams showing an embodiment of a storage system that manages snapshot functionality by distributing data across a plurality of shapshots.

FIG. 5 is a schematic block diagram illustrating an embodiment of a computer system for usage in a storage system that manages snapshot functionality by distributing data across a plurality of shapshots.

### DETAILED DESCRIPTION

Storage devices can be configured in a manner that enables improved performance and reliability. For example, storage devices in the form of Redundant Arrays of Independent Disks (RAID) use two or more storage drives in combination to attain fault tolerance and performance. RAID storage arrays can be grouped into two types including traditional and virtual RAID storage array types. Traditional arrays are defined by a rigid mapping of address space from a host computer to physical media. Accordingly, in a traditional array, given the address at which the host computer accesses a particular piece of data, the data can be physically located on the actual storage drives that make up the RAID array. In a virtual array, at least one level of indirection, also called virtualization, exists between the address that the host computer uses to access a particular piece of data on that array and the actual physical location of that data on the storage drives that make up the RAID array. In the virtual array in which the specific host address for the data piece is known, the actual physical location of that data can be on any of the drives in the array. The layer of indirection that exists in the virtual array is generated by a mapping from host-based addresses to the physical location of data on the storage drives.

Mappings enable virtual array functionality and can be used to assist in a capability to make snapshot copies of stored data volumes. A snapshot copy saves information enabling a point-in-time copy of a selected data set. In a traditional array, a snapshot copy is attained by suspending writes to the volume being copied, preserving the volume state at the point-in-time, followed by copying of every piece of data from the volume being copied to the new address space that represents the point-in-time copy. Only after every data piece from the original volume is copied are writes to the volume being copied resumed. Depending on the snapshot size, for example the amount of data copied, the process can take an unacceptable amount of time.

With a virtual array, the snapshot process can be greatly simplified. As a byproduct of virtualization, maps from the original volume of addresses to the associated physical locations already exist. Using the virtualization mappings, a point-in-time copy can be created simply by copying the maps to the new address space that represents the point-in-time copy. In a typical implementation, both the original host address and the associated snapshot copy address are mapped to the same physical locations on the storage devices. Thus, a snapshot completes in the small amount of time taken to copy the maps. The virtual arrays enable snapshot functionality that proceeds much more quickly than the traditional array operation of copying all data from one physical location to another.

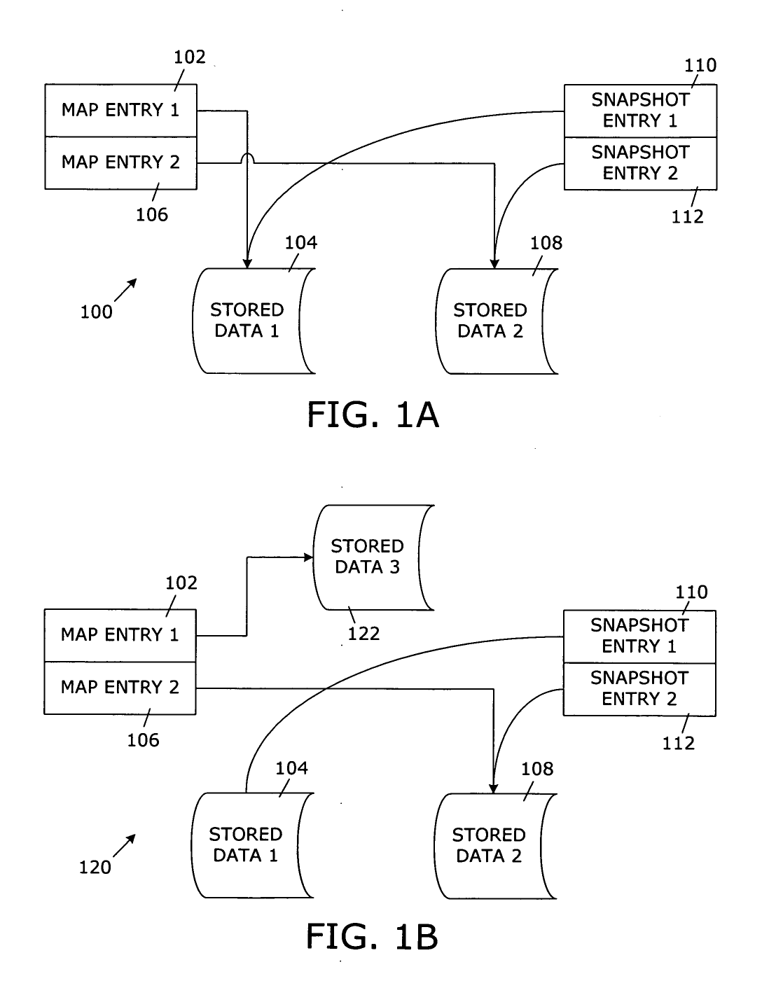

However, the virtual array snapshot technique does leave unresolved the problem of subsequent data modification. Modification of the original data can occur under two conditions. In a first condition, illustrated in the schematic block diagrams shown in FIGS. 1A and 1B, granularity of the array's maps is the same as the granularity that the divergence between the snapshot copy and the original data is recorded within the array. Granularity can be defined, for example, as the size of the contiguous physical area that is defined by one map entry. Accordingly, in the condition 100 shown in FIGS. 1A and 1B, the granularity of divergence corresponds exactly with the size and location of map entries.

FIG. 1A shows the condition 100 prior to the writing of new data to Map Entry 1 102. Map Entry 1 102 points to Stored Data 1 104. Map Entry 2 106 points to Stored Data 2 108. Snapshot Entry 1 110 also points to Stored Data 1 104. Snapshot Entry 2 112 also points to Stored Data 2 106.

FIG. 1B shows the condition 120 after new data is written to Map Entry 1 102. In the virtual array, the snapshot is taken by writing the modified original data to a new location, labeled in the illustrative example as Stored Data 3 122. The snapshot copy, shown as Snapshot Entry 1 110 remains pointed to the original physical data in the original location, shown as Stored Data 1 104. The original data labeled Map Entry 1 102 is changed to point to the new physical location 122. Thus, divergence of the snapshot copy and the original data is attained by writing the new data in a new location.

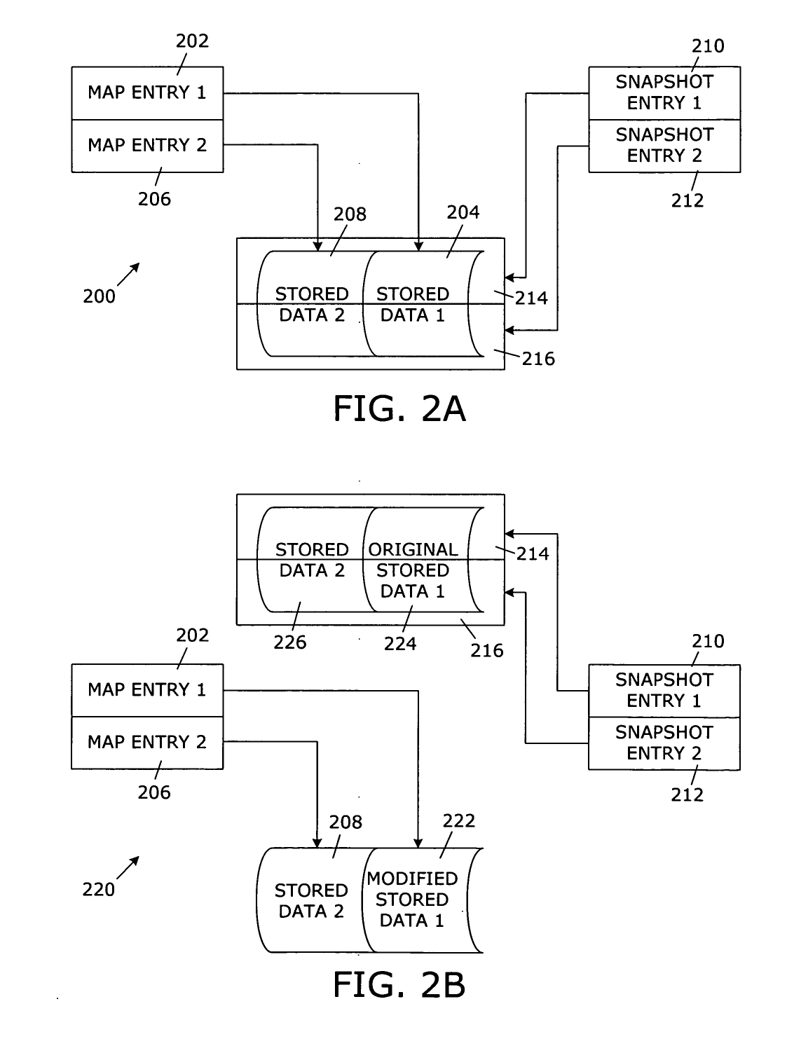

The technique is functional when the granularity of the array's maps is the same as the granularity of divergence. In an alternative condition, shown in FIGS. 2A and 2B, snapshot divergence is shown in the condition 200 when divergence granularity and map granularity are different. FIG. 2A shows the condition 200 prior to the writing of new data to Map Entry 1 202. Map Entry 1 202 points to Stored Data 1 204. Map Entry 2 206 points to Stored Data 2 208. Snapshot Entry 1 210 points to snapshot target data 214 and Snapshot Entry 2 212 points to snapshot target data 216.

FIG. 2B illustrates the condition 220 after new data is written to Map Entry 1 202. Before the storage locations holding the original data, labeled Stored Data 1 204 can be written, forming Modified Stored Data 1 222, the original data is copied from the original location in Stored Data 1 204 to another physical location, illustrated as Original Stored Data 1 224, to maintain an appropriate point-in-time copy. The Snapshot Entries 1 210 and 2 212 point to the new physical location that now respectively contains the snapshot target data 214 and snapshot target data 216. Not only the original data, Stored Data 1 204, but all original data associated with the snapshot is copied to the new physical location so that the Snapshot Entry 1 210 and Snapshot Entry 2 212 continue to point to a complete point-in-time copy. In the illustrative example shown in FIG. 2B, the Stored Data 2 208 is copied to the new physical location 226. To maintain the original data, content of the physical storage locations is not modified until the original data is copied. One difficulty of the snapshot operation is that modification of one data piece can cause the copying of much more data, possibly causing dramatic increase the time expended for data modification compared to a system that does not use snapshots.

One example of a data modification that can have a dramatic effect on performance is deletion of the original data, possibly causing numerous data pieces to be copied in a very short time period. The problem compounds if multiple snapshots are taken of the same data. In a traditional system, when a parent logical unit (LUN) is deleted, data is written to the first shapshot and all other shapshots are pointed to the first. If the first snapshot is then deleted, the data will all be rewritten to the next, for example second, snapshot and all remaining shapshots will then be pointed to the second shapshot. If the second snapshot is subsequently deleted, then the same operation is again performed with all data will again be rewritten to subsequent shapshots. In this manner, all of the data in a given snapshot can be copied numerous times depending on when particular snapshots are deleted, thereby wasting time and resources in unproductive copying.

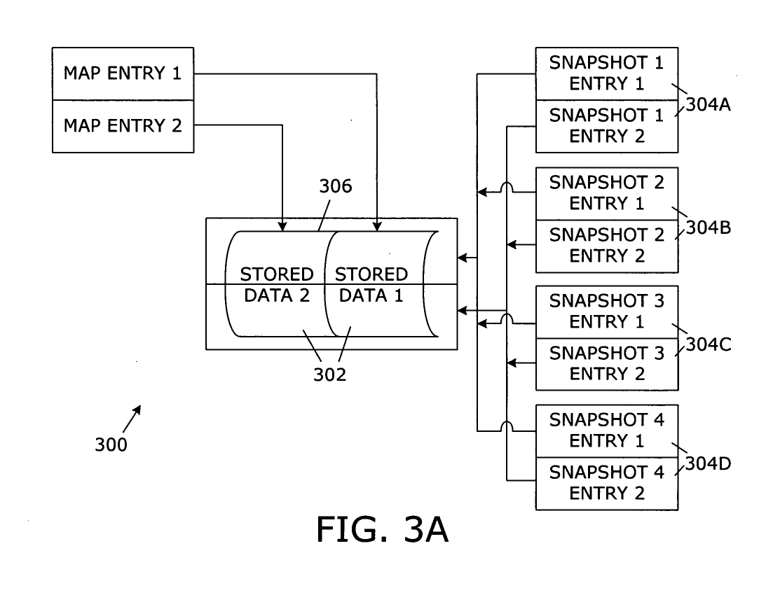

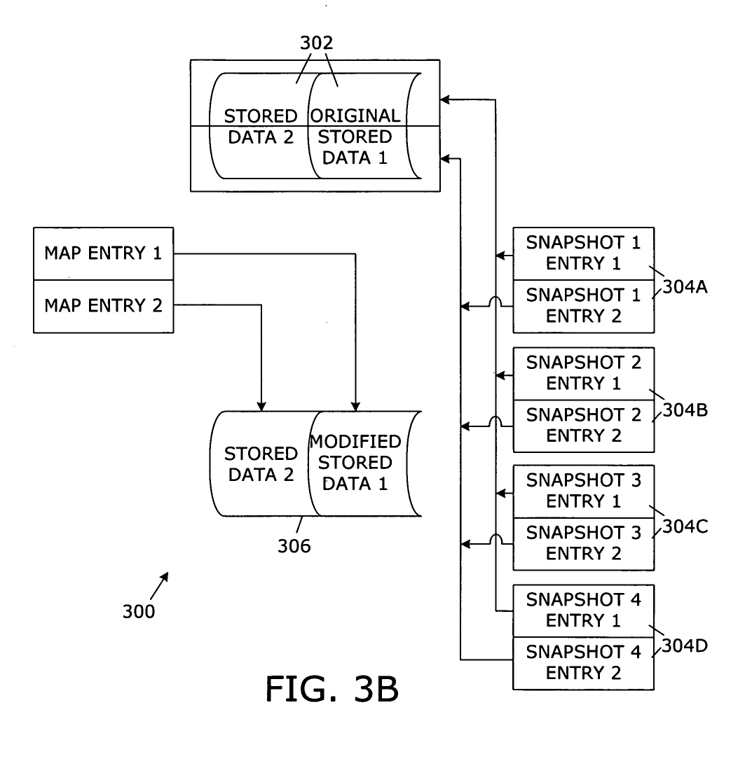

According to various embodiments of an improved storage system and storage system handling techniques, when divergence occurs, instead of copying all of the data to one snapshot, a portion of the data is distributed across multiple snapshots. Data divergence can occur, for example, when a parent logical unit (LUN) is deleted. Referring to FIGS. 3A and 3B, perspective block diagrams illustrate a storage configuration 300 associated with an embodiment of a method of protecting data. The method involves distributing data 302 across a plurality of snapshots 304A, B, C, and D of a parent logical unit (LUN) 306 when data of the parent LUN diverges from the snapshots.

Various types of parent LUN data divergence conditions can be selected for detection including deletion of a parent LUN, data write operations to the parent LUN, and failure of the parent LUN. Following detection of divergence of the parent LUN data, the diverged data can be distributed into a plurality of portions and the distributed data portions written to the plurality of shapshots. In some embodiments, the data can be distributed across the plurality of snapshots in substantially equal proportions.

The number of snapshots can vary over time. Upon modification of the number of snapshots, the data can be distributed substantially evenly over the plurality of snapshots. Data is distributed substantially or approximately equally over the snapshots not only for conditions of mathematically-precise allocation of data, but also includes situations in which exact precision is not possible or desirable. For example, the data may not be equally divisible into a particular number of snapshots at a particular granularity of data. Accordingly, the data may be distributed to allocated snapshots in the data in a roughly equal distribution.

The snapshot data can be stored on any suitable media including, for example, magnetic disks, optical disks, compact disk (CD), CD-R, CD-RW, diskettes, tapes, tape cartridges, and the like.

By responding to data divergence and copying a portion of the data to each snapshot of multiple snapshots, the particular snapshot that “owns” any particular part of the data varies and, if a single snapshot is deleted, only a portion of the data is to be recopied. Benefits of the technique increase as the number of snapshots increases. For example, a system configured with a single snapshot has no advantage, but as the number of snapshots increases to two or more, performance is improved.

The conditions illustrated in FIGS. 3A and 3B depict a parent LUN that has four snapshots 304A, B, C, and D. In conventional practice of a storage system with snapshot capability, if a parent LUN is deleted, then all data is copied to the first snapshot and the remaining three snapshots are pointed at the first snapshot. If the first snapshot is subsequently deleted, then all data is copied to the second snapshot and again the remaining third and fourth snapshots are pointed at the second snapshot. In the worst possible case, data is copied four times.

In contrast, the technique illustrated in FIGS. 3A and 3B substantially reduces copying as a result of data divergence. When divergence occurs, for example deletion of a parent LUN, instead of copying all of the data to the first snapshot 304A, one-fourth of the data can be copied to each of the snapshots 304A, B, C, and D. If a snapshot is deleted, data is correctly managed by recopying only one-fourth of the data, and the recopied data is distributed over the three remaining snapshots. If another snapshot is to be deleted, only one-third of the data is recopied and the recopied data is distributed evenly across the two remaining snapshots. Finally, if one of the remaining snapshots is deleted, only half of the data is recopied to the last remaining snapshot. Accordingly, after the first parent LUN deletion and subsequent data copy, only ¼+⅓+½ of the data is copied for the worst case on subsequent snapshot deletions. In contrast, the conventional technique would possibly copy all of the data three more times following the initial parent LUN deletion.

Although the illustrative example describes a divergence event as deletion of a parent LUN, the technique is similarly applicable to any circumstance that causes the parent LUN and the snapshot to diverge. Divergence events also include diverging writes to the parent LUN as well as other events. Accordingly, the technique can be used to distribute data as diverging writes are sent to the parent LUN in another example. Thus, one diverging write can be used to copy original data to one snapshot and a next diverging write can copy the copied data to the next snapshot and so on so that individual snapshots “own” essentially equal portions of the diverging data.

At any given time, data is distributed essentially evenly over only the existing snapshots, thereby reducing the copying burden of the snapshot managing system. In an example in which a parent LUN already has two existing shapshots, over time the two snapshots evenly share all of the diverged data from the parent LUN. When a third snapshot of the parent is taken, the new snapshot need not be “favored” to eventually receive as much diverged data as the original two snapshots because the third snapshot does not share any of the diverged data previously received by the original two snapshots. Thus, at the time the third snapshot comes into existence, the diverging writes are only then distributed evenly over the three snapshots. Events occurring prior to the creation of the third snapshot are irrelevant to the current distribution. The distribution allocation is only determined by the number of snapshots currently in existence.

The concept of distributing data substantially evenly across multiple snapshots of a parent LUN when data of the parent LUN diverges from the snapshots is capable of generalization to any reason, circumstance, or condition that results in divergence between the parent LUN and the snapshot. The technique can be further generalized to any suitable storage method that supports snapshot functionality, possibly including various Redundant Array of Independent Disk (RAID) types including one or more of RAID0, RAID1, RAID2, RAID3, RAID4, RAID5, RAID6, RAID7, RAID10, and the like. Similarly, the technique can be used for any suitable storage media that supports snapshot functionality, perhaps including various magnetic disks, optical disks, compact disk (CD), CD-R, CD-RW, diskettes, tapes, tape cartridges, and the like. Also, the technique may be further generalized to any appropriate divergence origin, condition, storage method or media that supports snapshot functionality in future developments.

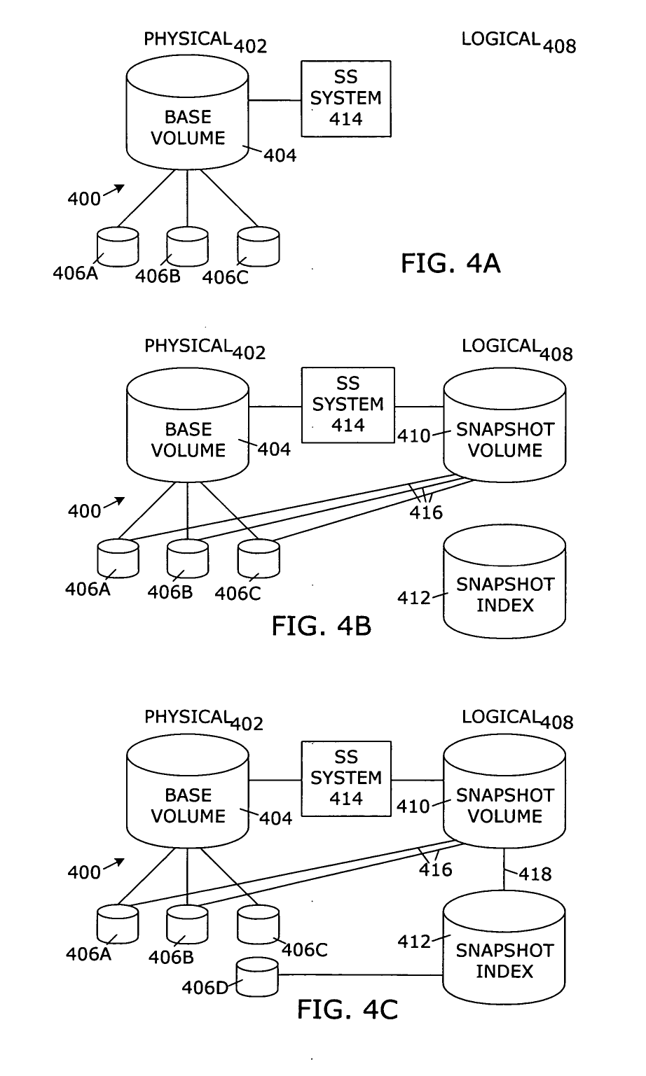

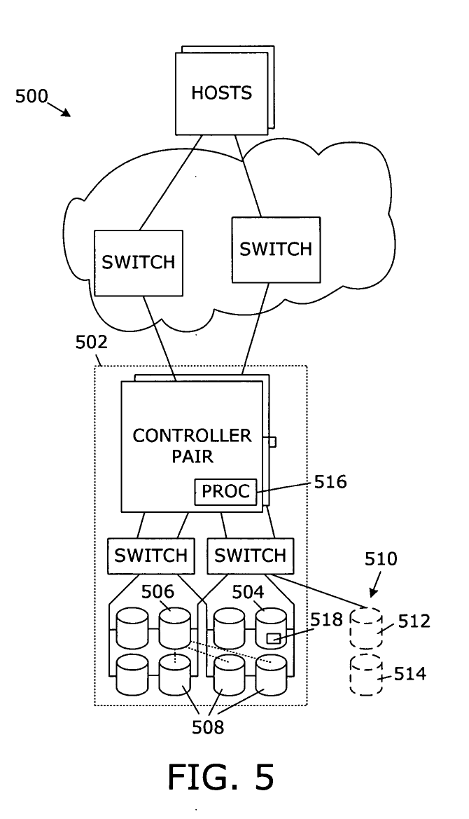

Referring to FIGS. 4A, 4B, and 4C, pictorial block diagrams illustrate an embodiment of a storage system 400 including a physical store 402 with a base volume 404 and at least one physical block 406A, B, C, and D, and a logical store 408 including a snapshot volume 410 and a snapshot index 412. The storage system 400 further includes a snapshot subsystem 414 capable of supporting pointers from the snapshot volume to selected ones of the physical blocks at a point-in-time. The snapshot subsystem 414 defines a parent logical unit (LUN), and distributes data across a plurality of snapshots of the parent LUN when data of the parent LUN diverges from the snapshots.

In various embodiments, the physical store 402 and logical store 408 can store snapshot data on a media selected from among magnetic disks, optical disks, compact disk (CD), CD-R, CD-RW, diskettes, tapes, tape cartridges, and the like.

The storage system 400 can also include one or more map pointers 416 in the snapshot volume 410 that points to data in the physical store 402 and multiple snapshot pointers 418 capable of pointing to data in the snapshot index 412. The snapshot subsystem 414 distributes diverged data into a plurality of snapshot portions in the snapshot index 412 and writes the distributed data portions to the plurality of shapshots.

In some embodiments or conditions, the snapshot subsystem 414 distributes data across the plurality of snapshots in substantially equal proportions. The snapshot subsystem 414 can also be configured to detect parent LUN data divergence conditions selected from among including deletion of the parent LUN, data write operations to the parent LUN, failure of the parent LUN, and the like.

The snapshot subsystem 414 may also be configured to modify the number of snapshots over time and distribute data substantially evenly among the plurality of snapshots beginning at each modification.

The snapshot subsystem 414 enables a fast and efficient capability to create a point-in-time copy of storage container data. The snapshot freezes a map of the container's data that can be isolated from other snapshots and used for backup, archiving, data protection, testing, and other manipulation without compromising the original data. After a snapshot is taken, the original data can continue to be updated and used while the snapshot copy maintains the selected point-in-time.

When a duplicate copy of a particular point-in-time is desired, the snapshot subsystem 414 directs acquisition of a data snapshot at the selected instant. Typically, a snapshot subsystem 414 can acquire multiple snapshots, enabling repeated acquisitions. The snapshot capability avoids some of the overhead associated with data mirroring and cloning.

Referring to FIG. 5, a schematic block diagram illustrates an embodiment of a computer system 500 for usage in a storage system 502 with a physical store 504 including a base volume 506 and at least one physical block 508 and a logical store 510 including a snapshot volume 512 and a snapshot index 514. The computer system further includes a snapshot subsystem executable in a processor 516 that distributes data across a plurality of snapshots of a parent LUN 518 when data of the parent LUN 518 diverges from the snapshots.

The processor 516 can implement a mapping logic that defines the base volume 506 and allocates the physical blocks 508 to the base volume 506, and creates pointers from the snapshot volume 512 to selected physical blocks 508 and to the snapshot index 514.

A processor 516 that executes snapshot management functionality can be located in any suitable device in a network. As illustrated, the processor 516 can be contained within a storage controller. In other embodiments, a processor capable of executing snapshot functionality can be in a host, a suitable control device within a storage array network (SAN), a network appliance attached to a network, array firmware, or any other level of execution that can perform a point-in-time copy.

The process of data distribution to a plurality of snapshots can be implemented in various operations, such as programmable operations, including copy-before-write operations, copy-on-write operations, and the like.

The processor 516 can further execute a mapping logic that generates one or more map pointers in the snapshot volume 512 that points to data in the physical store 504 and one or more snapshot pointers capable of pointing to data in the snapshot index 514. The processor 516 can further execute a snapshot logic that distributes diverged data into a plurality of snapshot portions in the snapshot index 514 and writes the distributed data portions to the multiple shapshots. Data can be most efficiently distributed across the multiple snapshots in equal or approximately equal proportions.

The processor 516 can detect one or more parent LUN data divergence conditions including deletion of a parent LUN, data write operations to a parent LUN, failure of a parent LUN, and the like.

The processor 516 can execute a snapshot handler that modifies the number of snapshots over time and distributes data substantially evenly among the plurality of snapshots beginning at each modification. Typically, the system allocates a particular maximum number of snapshots and begins creating snapshots upon selected events, such as timing intervals, activations signals, monitored conditions, and the like. The number of snapshots is typically limited to a selected number, although some implementations may support virtually unlimited snapshots.

The physical store 504 may include any storage devices that are suitable for snapshot functionality and may include various media such as magnetic disks, optical disks, compact disk (CD), CD-R, CD-RW, diskettes, tapes, and tape cartridges.

The various functions, processes, methods, and operations performed or executed by the system can be implemented as programs that are executable on various types of logic, processors, controllers, central processing units, microprocessors, digital signal processors, state machines, programmable logic arrays, and the like. The programs can be stored on any computer-readable medium for use by or in connection with any computer-related system or method. A computer-readable medium is an electronic, magnetic, optical, or other physical device or means that can contain or store a computer program for use by or in connection with a computer-related system, method, process, or procedure. Programs can be embodied in a computer-readable medium for use by or in connection with an instruction execution system, device, component, element, or apparatus, such as a system based on a computer or processor, or other system that can fetch instructions from an instruction memory or storage of any appropriate type. A computer-readable medium can be any structure, device, component, product, or other means that can store, communicate, propagate, or transport the program for use by or in connection with the instruction execution system, apparatus, or device.

The illustrative block diagrams and data structure diagrams depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims. For example, the illustrative snapshot techniques may be implemented in any types of storage systems that are appropriate for such techniques, including any appropriate media. Similarly, the illustrative techniques may be implemented in any appropriate storage system architecture.

1. A method of protecting data comprising:
distributing data across a plurality of snapshots of a parent logical unit (LUN) when data of the parent LUN diverges from the snapshots.

2. The method according to claim 1 further comprising:
detecting divergence of the parent LUN data;
distributing the diverged data into a plurality of portions; and
writing the distributed data portions to the plurality of shapshots.

3. The method according to claim 1 further comprising:
distributing data across the plurality of snapshots in substantially equal proportions.

4. The method according to claim 1 wherein:
parent LUN data divergence conditions include deletion of the parent LUN, data write operations to the parent LUN, and failure of the parent LUN.

5. The method according to claim 1 further comprising:
modifying the number of snapshots over time; and
distributing data substantially evenly among the plurality of snapshots beginning at each modification.

6. The method according to claim 1 further comprising:
storing snapshot data on a media selected from among magnetic disks, optical disks, compact disk (CD), CD-R, CD-RW, diskettes, tapes, and tape cartridges.

7. A storage system comprising:
a physical store comprising a base volume and at least one physical block;
a logical store comprising a snapshot volume and a snapshot index; and
a snapshot subsystem capable of supporting pointers from the snapshot volume to selected ones of the physical blocks at a point-in-time, defining a parent logical unit (LUN), and distributing data across a plurality of snapshots of the parent LUN when data of the parent LUN diverges from the snapshots.

8. The storage system according to claim 7 further comprising:
at least one map pointer in the snapshot volume that points to data in the physical store;
a plurality of snapshot pointers capable of pointing to data in the snapshot index; and
the snapshot subsystem that distributes diverged data into a plurality of snapshot portions in the snapshot index and writes the distributed data portions to the plurality of shapshots.

9. The storage system according to claim 8 wherein:
the snapshot subsystem distributes data across the plurality of snapshots in substantially equal proportions.

10. The storage system according to claim 7 wherein:
the snapshot subsystem is capable of detecting parent LUN data divergence conditions including deletion of the parent LUN, data write operations to the parent LUN, and failure of the parent LUN.

11. The storage system according to claim 7 wherein:
the snapshot subsystem is capable of modifying the number of snapshots over time and distributing data substantially evenly among the plurality of snapshots beginning at each modification.

12. The storage system according to claim 7 further comprising:
storing snapshot data on a media selected from among magnetic disks, optical disks, compact disk (CD), CD-R, CD-RW, diskettes, tapes, and tape cartridges.

13. A computer system for usage in a storage system with a physical store including a base volume and at least one physical block and a logical store including a snapshot volume and a snapshot index, the computer system comprising:
a snapshot subsystem that distributes data across a plurality of snapshots of a parent LUN when data of the parent LUN diverges from the snapshots.

14. The computer system according to claim 13 further comprising:
a mapping logic that defines a base volume and allocates the at least one physical block to the base volume, and creates pointers from the snapshot volume to selected ones of the physical blocks and to the snapshot index.

15. The computer system according to claim 13 further comprising:
a mapping logic that generates at least one map pointer in the snapshot volume that points to data in the physical store and a plurality of snapshot pointers capable of pointing to data in the snapshot index; and
a snapshot logic that distributes diverged data into a plurality of snapshot portions in the snapshot index and writes the distributed data portions to the plurality of shapshots.

16. The computer system according to claim 15 further comprising:
a logic associated with the snapshot logic that distributes data across the plurality of snapshots in substantially equal proportions.

17. The computer system according to claim 13 further comprising:
a logic associated with the snapshot logic that detects parent LUN data divergence conditions including deletion of the parent LUN, data write operations to the parent LUN, and failure of the parent LUN.

18. The computer system according to claim 13 further comprising:
a logic associated with the snapshot logic that modifies the number of snapshots over time and distributes data substantially evenly among the plurality of snapshots beginning at each modification.

19. The computer system according to claim 13 further comprising:
at least one storage device capable of storing data on a media selected from among magnetic disks, optical disks, compact disk (CD), CD-R, CD-RW, diskettes, tapes, and tape cartridges.

20. The computer system according to claim 13 further comprising:
storage devices of the at least one storage device have a structure selected from among RAID0, RAID1, RAID2, RAID3, RAID4, RAID5, RAID6, RAID7, RAID10.
